(19) United States
(12) Patent Application Publication
(10) Pub. No.: US 2025/0328810 A1
(43) Pub. Date: Oct. 23, 2025

(54) SYSTEM AND METHOD FOR DEFINING A WEIGHTING SCHEME FOR A DATASET

(71) Applicant: The Toronto-Dominion Bank, Toronto (CA)

(72) Inventors: Thomas Nicholas YURKIW, Toronto (CA); John PAPPALARDO, Toronto (CA); Kent Douglas WOOLLAM, Regina (SK)

(73) Assignee: The Toronto-Dominion Bank, Toronto (CA)

(21) Appl. No.: 18/639,075

(22) Filed: Apr. 18, 2024

(51) Int. Cl. G06N 20/00

(52) U.S. Cl. CPC G06N 20/00

(57) ABSTRACT

A computer system comprises a communications module; at least one processor coupled to the communications module; and a memory coupled to the at least one processor and storing processor-executable instructions which, when executed by the at least one processor, configure the at least one processor to send, via the communications module, a request for a proposed weight value for at least one data point in a dataset; receive, via the communications module, the proposed weight value for the at least one data point based on analysis of the at least one data point; define a weighting scheme for the dataset based at least on the proposed weight value for the at least one data point; and apply the weighting scheme to the dataset. Artificial intelligence may be used to identify biases within the dataset.

### TECHNICAL FIELD

The present application relates to systems and methods for defining a weighting scheme for a dataset.

### BACKGROUND

Weighting is often used in the training of artificial intelligence (AI) models especially in machine learning and neural networks.

Weighting requires assigning different levels of importance to various features in a dataset during a training process. Properly applied weighting improves AI model performance.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computer system;

FIG. 3 shows a simplified organization of software components stored in a memory of the example computer system of FIG. 2;

FIG. 4 is a flowchart showing operations performed by a server computer system in defining a weighting scheme for a dataset according to an example embodiment; and

FIGS. 5 to 8 are example graphical user interfaces for analyzing at least one data point based on defined criteria according to example embodiments.

Like reference numerals are used in the drawings to denote like elements and features.

### DETAILED DESCRIPTION OF VARIOUS EMBODIMENTS

Accordingly, in one aspect there is provided a computer system comprising a communications module; at least one processor coupled to the communications module; and a memory coupled to the at least one processor and storing processor-executable instructions which, when executed by the at least one processor, configure the at least one processor to send, via the communications module, a request for a proposed weight value for at least one data point in a dataset; receive, via the communications module, the proposed weight value for the at least one data point based on analysis of the at least one data point; define a weighting scheme for the dataset based at least on the proposed weight value for the at least one data point; and apply the weighting scheme to the dataset.

In one or more embodiments, the at least one data point includes a first data point and the processor-executable instructions, when executed by the at least one processor, further configure the at least one processor to identify a first source for generating a first proposed weight value for the first data point; send, via the communications module and to a computing device associated with the first source, a request for the first proposed weight value for the first data point; and receive, via the communications module and from the computing device associated with the first source, the first proposed weight value for the first data point.

In one or more embodiments, the processor-executable instructions, when executed by the at least one processor, further configure the at least one processor to identify a second source for generating a second proposed weight value for the first data point; send, via the communications module and to a computing device associated with the second source, a request for the second proposed weight value for the first data point; and receive, via the communications module and from the computing device associated with the second source, the second proposed weight value for the first data point.

In one or more embodiments, the processor-executable instructions, when executed by the at least one processor, further configure the at least one processor to define a weight value for the first data point based at least on the first proposed weight value and the second proposed weight value.

In one or more embodiments, the at least one data point includes a first data point and a second data point and the processor-executable instructions, when executed by the at least one processor, further configure the at least one processor to identify a first source for generating a first proposed weight value for the first data point and a second source for generating a second proposed weight value for the second data point; send, via the communications module and to a computing device associated with the first source, a request for the first proposed weight value for the first data point; send, via the communications module and to a computing device associated with the second source, a request for the second proposed weight value for the second data point; receive, via the communications module and from the computing device associated with the first source, the first proposed weight value for the first data point; and receive, via the communications module and from the computing device associated with the second source, the second proposed weight value for the second data point.

In one or more embodiments, the processor-executable instructions, when executed by the at least one processor, further configure the at least one processor to define the weighting scheme based at least on the first proposed weight value for the first data point and the second proposed weight value for the second data point.

In one or more embodiments, the weighting scheme includes a weight value for each identified data point in the dataset.

In one or more embodiments, the processor-executable instructions, when executed by the at least one processor, further configure the at least one processor to determine a trigger condition; and responsive to determining the trigger condition, send, via the communications module, the request for the proposed weight value for the at least one data point.

In one or more embodiments, the analysis of the at least one data point includes analyzing the at least one data point based on defined criteria.

In one or more embodiments, sending the request for the proposed weight value of the at least one data point includes sending, via the communications module, a graphical user interface that includes at least one interface element for analyzing the at least one data point based on the defined criteria.

According to another aspect there is provided a computer-implemented method comprising sending, via a communications module, a request for a proposed weight value for at least one data point in a dataset; receiving, via the communications module, the proposed weight value for the at least one data point based on analysis of the at least one data point; defining a weighting scheme for the dataset based at least on the proposed weight value for the at least one data point; and applying the weighting scheme to the dataset.

In one or more embodiments, the at least one data point includes a first data point and the method further comprises identifying a first source for generating a first proposed weight value for the first data point; sending, via the communications module and to a computing device associated with the first source, a request for the first proposed weight value for the first data point; and receiving, via the communications module and from the computing device associated with the first source, the first proposed weight value for the first data point.

In one or more embodiments, the method further comprises identifying a second source for generating a second proposed weight value for the first data point; sending, via the communications module and to a computing device associated with the second source, a request for the second proposed weight value for the first data point; and receiving, via the communications module and from the computing device associated with the second source, the second proposed weight value for the first data point.

In one or more embodiments, the method further comprises defining a weight value for the first data point based at least on the first proposed weight value and the second proposed weight value.

In one or more embodiments, the at least one data point includes a first data point and a second data point and the method further comprises identifying a first source for generating a first proposed weight value for the first data point and a second source for generating a second proposed weight value for the second data point; sending, via the communications module and to a computing device associated with the first source, a request for the first proposed weight value for the first data point; sending, via the communications module and to a computing device associated with the second source, a request for the second proposed weight value for the second data point; receiving, via the communications module and from the computing device associated with the first source, the first proposed weight value for the first data point; and receiving, via the communications module and from the computing device associated with the second source, the second proposed weight value for the second data point.

In one or more embodiments, the method further comprises defining the weighting scheme based at least on the first proposed weight value for the first data point and the second proposed weight value for the second data point.

In one or more embodiments, the weighting scheme includes a weight value for each identified data point in the dataset.

In one or more embodiments, the analysis of the at least one data point includes analyzing the at least one data point based on defined criteria.

In one or more embodiments, sending the request for the proposed weight value of the at least one data point includes sending, via the communications module, a graphical user interface that includes at least one interface element for analyzing the at least one data point based on the defined criteria.

According to another aspect there is provided a non-transitory computer readable medium having stored thereon processor-executable instructions which, when executed by at least one processor, configure the at least one processor to send, via a communications module, a request for a proposed weight value for at least one data point in a dataset; receive, via the communications module, the proposed weight value for the at least one data point based on analysis of the at least one data point; define a weighting scheme for the dataset based at least on the proposed weight value for the at least one data point; and apply the weighting scheme to the dataset.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

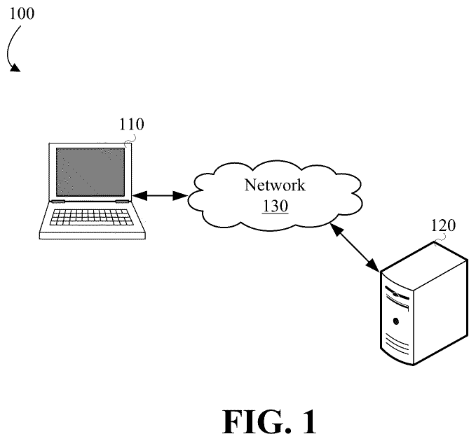

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

As will be described in more detail below, the server computer system 120 may be configured to define a weighting scheme for a dataset. The weighting scheme may be based at least on a proposed weight value for at least one data point in the dataset.

In one or more embodiments, the computing device 110 may be associated with a source for generating a proposed weight value for at least one data point in the dataset.

Although in FIG. 1 only a single computing device 110 is shown, it will be appreciated that the system 100 may include a plurality of computing devices that may be of the same type as the computing device 110. Each computing device may be associated with a particular source for generating a proposed weight value for at least one data point in the dataset.

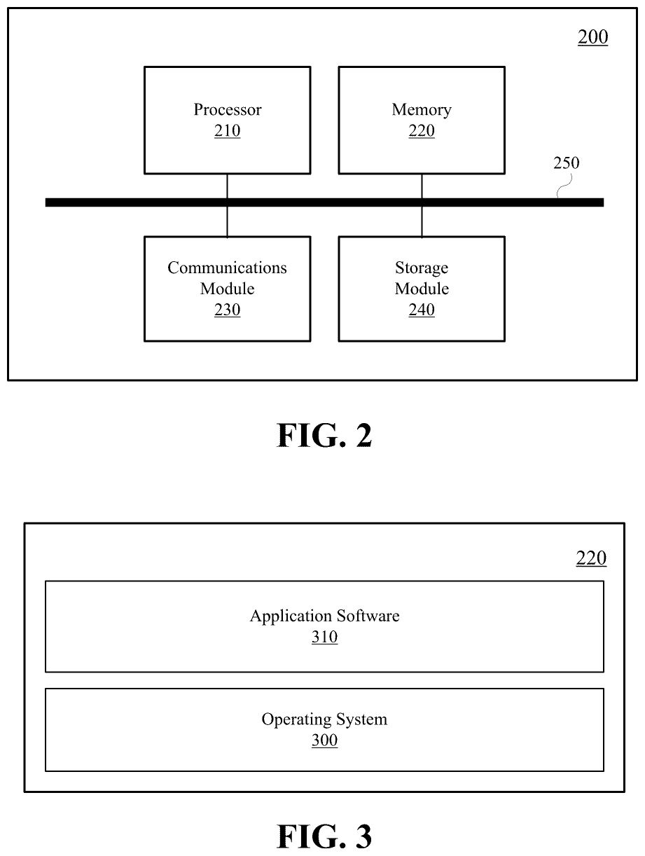

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application software 310.

The operating system 300 is software. The operating system 300 allows the application software 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application software 310 adapts the computer system 200, in combination with the operating system 300, to operate as a device for performing a specific function. For example, the application software 310 may cooperate with the operating system 300 to adapt a suitable embodiment of the example computer system 200 to operate as the computing device 110 and/or the server computer system 120.

The server computer system 120 may define a weighting scheme for a dataset. The dataset may include a plurality of data points and the weighting scheme may include or otherwise define a weight value for each data point in the dataset. The data set may include a training data set that may be used for training one or more AI models associated with machine learning and/or neural networks.

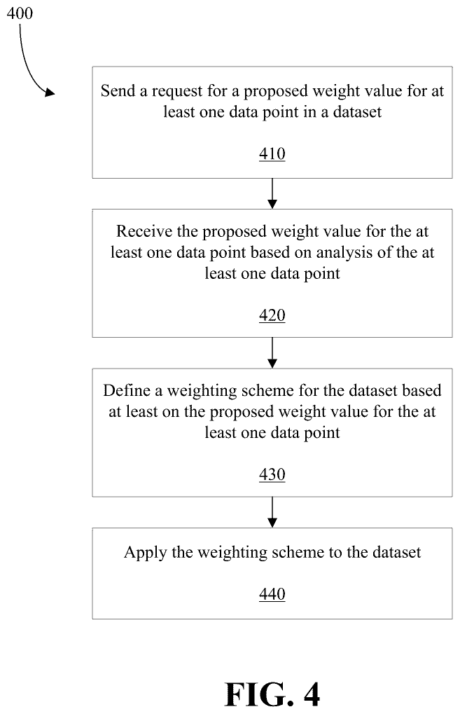

Reference is made to FIG. 4, which illustrates, in flowchart form, a method 400 for defining a weighting scheme for a dataset. The method 400 may be implemented by a computing device having suitable processor-executable instructions for causing the computing device to carry out the described operations. The method 400 may be implemented, in whole or in part, by the server computer system 120.

The method 400 includes sending a request for a proposed weight value for at least one data point in a dataset (step 410).

The proposed weight value for the at least one data point may include a value assigned by one or more sources that may be used to define a weighting scheme for the dataset. The proposed weight value may include a numerical value that may include, for example, a decimal, an integer, or a percentage. The proposed weight value may include a weight value that is proposed by a particular source. For example, the source may propose or otherwise recommend the weight value based on an analysis of the at least one data point. For example, the source may propose the weight value based on a determination of whether or not the data point is considered to be biased and/or based on a determination of whether or not the dataset is imbalanced. The proposed weight value may be based on sample weighting, class weighting, etc.

In one or more embodiments, the server computer system 120 may identify one or more sources for generating the proposed weight value for the at least one data point in the dataset. For example, the at least one data point may include a first data point. The server computer system 120 may identify a first source for generating a first proposed weight value for the first data point.

In one or more embodiments, the first source may include, for example, an artificial intelligence (AI) based module that may be trained to analyze data sets to identify potential biases within a dataset. The AI module may be internal to the server computer system 120 or may be associated with a computing device that is in communication with the server computer system 120 via a network.

In one or more embodiments, the first source may be an operator such as a computer programmer and data scientist and as such the server computer system 120 may communicate with a computing device associated with the first source.

It will be appreciated that more than one source may be identified to generate a proposed weight value for the at least one data point in the dataset. For example, the at least one data point may include a first data point. The server computer system 120 may identify a first source for generating a first proposed weight value for the first data point and may identify a second source for generating a second proposed weight value for the first data point.

It will be appreciated that different sources may be identified to generate proposed weight values for different data points in the dataset. For example, the at least one data point may include a first data point and a second data point. The server computer system 120 may identify a first source for generating a first proposed weight value for the first data point and a second source for generating a second proposed weight value for the second data point.

In one or more embodiments, the server computer system 120 may identify the one or more sources for generating the proposed weight value for the at least one data point based on a lookup table. For example, the server computer system 120 may maintain a database that includes a lookup table that maps data points to sources for generating the proposed weight value for the data points. For example, the at least one data point may include a first data point and the lookup table may map the first data point to one or more sources for generating a proposed weight value for the first data point. Further, the at least one data point may include a second data point and the lookup table may map the second data point to one or more sources for generating a proposed weight value for the second data point.

In one or more embodiments, each data point in the dataset may have a dedicated source or combination of sources that may be responsible for generating the proposed weight value therefore. Further, a source may generate a proposed weight value for more than one data point. For example, a first source may generate a proposed weight value for a first data point and a second data point in the dataset. A second source may generate a proposed weight value for the second data point in the dataset and a third data point in the dataset. A third source may generate a proposed weight value for the third data point in the dataset.

In one or more embodiments, the source for generating the proposed weight value for a particular data point may be assigned randomly. For example, the server computer system 120 may identify a list of all sources and may perform operations to randomly assign each source to one or more data points.

In one or more embodiments, the server computer system 120 may send the request for a proposed weight value to a computing device associated with the source for generating the proposed weight value.

For example, as mentioned, the server computer system 120 may identify a first source for generating a first proposed weight value for the first data point. As such, the server computer system 120 may send, to a computing device associated with the first source, a request for the first proposed weight value for the first data point. Further, as mentioned, the server computer system 120 may identify a second source for generating a second proposed weight value for the first data point. As such, the server computer system 120 may send, to a computing device associated with the second source, a request for the second proposed weight value for the first data point.

As another example, as mentioned, the server computer system 120 may identify a first source for generating a first proposed weight value for the first data point and a second source for generating a second proposed weight value for the second data point. As such, the server computer system 120 may send, to a computing device associated with the first source, a request for the proposed weight value for the first data point and may send, to a computing device associated with the second source, a request for the proposed weight value for the second data point.

In one or more embodiments, the request may be sent to a computing device associated with a source for generating a proposed weight value for at least one data point in the form of an electronic communication. For example, a message such as an email message may be sent to an email address associated with the source that includes a selectable link that, when selected, directs the computing device associated with the source to a graphical user interface for analyzing the at least one data point.

In one or more embodiments, the request for the proposed weight value for the at least one data point may be sent responsive to determining a trigger condition. A trigger condition may include determining that a new data set is available, receiving a request to define a weighting scheme for a data set, etc.

The method 400 includes receiving the proposed weight value for the at least one data point based on analysis of the at least one data point (step 420).

The server computer system 120 receives the proposed weight value for the at least one data point based on analysis of the at least one data point. For example, the source for generating the proposed weight value may perform a detailed analysis of the at least one data point and may propose a weight value based on the analysis. The detailed analysis of the at least one data point may include analyzing the dataset and the at least one data point.

In one or more embodiments, the analysis of the at least one data point may be based on defined criteria. For example, as mentioned, the first source may include an AI-based module that may be trained to analyze data sets to identify potential biases within a dataset. As such, the defined criteria may include criteria used to identify the potential biases within the dataset and this may be generated by the AI-based in response to training thereof. The defined criteria used may additionally or alternatively include one or more of class imbalance, data important or priority, misclassification costs, data quality or reliability, temporal or spatial considerations, performance evaluation, fairness considerations, etc.

As another example, as mentioned, the first source may include an operator such as a computer programmer or data scientist. As such, the operator may analyze the at least one data point based on defined criteria. For example, the defined criteria may include criteria to identify potential biases in a dataset. As another example, the defined criteria may include criteria to rank or otherwise score the at least one data point to determine the proposed weight value. For example, the first source may be provided a plurality of data points to generate proposed weight values therefore. In this example, the first source may rank or otherwise score the data points in comparison to one another. In this example, the proposed weight values may be required to add up to a certain threshold or value such as for example 1.00 or may be required to add up to 100%. As such, the first source may generate the proposed weight values for all data points assigned thereto such that they add up to the certain threshold.

The server computer system 120 may receive the proposed weight value for one or more data points from one or more sources. In one or more embodiments, the server computer system 120 may receive all proposed weight values for all data points in the dataset from one or more sources.

As one example, as mentioned, the server computer system 120 may identify a first source for generating a first proposed weight value for the first data point. As such, the server computer system 120 may receive, from the computing device associated with the first source, the first proposed weight value for the first data point. Further, as mentioned, the server computer system 120 may identify a second source for generating a second proposed weight value for the first data point. As such, the server computer system 120 may receive, from the computing device associated with the second source, the second proposed weight value for the first data point.

As another example, as mentioned, the server computer system 120 may identify a first source for generating a first proposed weight value for the first data point and a second source for generating a second proposed weight value for the second data point. As such, the server computer system 120 may receive, from the computing device associated with the first source, the proposed weight value for the first data point and may receive, from the computing device associated with the second source, the proposed weight value for the second data point.

As mentioned, the proposed weight value may include a numerical value that may include, for example, a decimal, an integer, or a percentage. As such, the server computer system 120 may receive the proposed weight value in the form of the numerical value.

The method 400 includes defining a weighting scheme for the dataset based at least on the proposed weight value for the at least one data point (step 430).

The server computer system defines a weighting scheme for the dataset based at least on the proposed weight value for the at least one data point.

In one or more embodiments, the weighting scheme may be defined as a sample weighting scheme. For example, the server computer system 120 may assign the weight values to the individual data points in the dataset. Each data point is associated with the weight value and this may determine the contribution of the data point to the training process. In this manner, the weighting scheme may be used to address class imbalance or to prioritize certain data points over others based on importance.

In one or more embodiments, the weighting scheme may be defined as a class weighting scheme. For example, the server computer system 120 may assign weight values to different classes or categories within the dataset.

In one or more embodiments, the weighting scheme may include a weight value for each identified data point in the dataset.

The weight value for a data point may be defined based at least on the proposed weight value received therefor. For example, a weight value for a first data point may be based at least on the first proposed weight value received from the first source and the second proposed weight value received from the second source.

The weight value for a data point may be based on all proposed weight values received for the data point. For example, the weight value for a datapoint may be calculated or set as the average of all proposed weight values received for the data point.

The weight value for all data points may be calculated or set based on the average of all proposed weight values received for the data point divided by the total sum of all weight values received. In this manner, the weight value for each data point may be set as a percentage of all weight values for all data points within the dataset. The total sum of all weight values may be a set value such as for example 1.0 or 100%.

Table 1 shows an example weighting scheme for data points DP1 to DP7 based on proposed weight values received from assigned sources S1 to S4:

TABLE 1

Source

| | S1 | S2 | S3 | S4 | Average | Weight Value |
|---|---|---|---|---|---|---|
| DP1 | 0.3 | 0.4 | | | 0.35 | 0.170731707 |
| DP2 | | 0.6 | 0.2 | | 0.4 | 0.195121951 |
| DP3 | | | 0.2 | 0.3 | 0.25 | 0.12195122 |
| DP4 | 0.3 | | 0.3 | | 0.3 | 0.146341463 |
| DP5 | | | 0.1 | | 0.1 | 0.048780488 |
| DP6 | | | 0.2 | 0.2 | 0.2 | 0.097560976 |
| DP7 | 0.4 | | | 0.5 | 0.45 | 0.219512195 |
| | 1 | 1 | 1 | 1 | 2.05 | 1 |

In the above table, source S1 has proposed weight values for data points DP1, DP4, and DP7. Source S2 has proposed weight values for data points DP1 and DP3. Source S3 has proposed weight values for data points DP2, DP3, DP4, DP5 and DP6. Source S4 has proposed weight values for data points DP3, DP6 and DP7. The average proposed weight value for each data point is calculated. The weight value for each data point is determined by dividing the average proposed weight value by the total sum of the average proposed weight vale for all data points (which is shown in Table 1 as 2.05). It will be appreciated that the sum of the average weight values defined by each source is 1.0. For example, the sum of the average weight values defined by source S1 is 0.3+0.3+0.4=1.0. Further, the sum of the weight values for all data points is 1.0.

The weight value for each data point may be a relative percentage. For example, as shown in Table 1, the weight value for data point DP1 is 0.170731707 which may be calculated as approximately 17.07%.

The weighting scheme for the dataset shown in Table 1 may be defined using the weight values shown therein.

The method 400 includes applying the weighting scheme to the dataset (step 440).

The server computer system 120 may apply the weighting scheme defined during the step 430 to the dataset. For example, the weighting scheme may apply the weight value to each data point in the dataset. In this manner, the weighting scheme may be applied to reflect the relative importance or contribution of each data point in the dataset.

In one or more embodiments, where the weighting scheme includes a sample weighting scheme, applying the sample weighting scheme may include creating a list of weight values corresponding to each data point in the dataset. The server computer system 120 may ensure that the weight values are aligned with the order of data points in the dataset, so each weight value corresponds to the correct data point.

The server computer system 120 may utilize the weighting scheme for machine learning. For example, when fitting a machine learning model to the dataset, the server computer system 120 may specify the weight values using the appropriate parameter or argument provided by the machine learning framework being used. The machine learning model may incorporate the sample weights during training, adjusting the contribution of each data point to the optimization objective or loss function accordingly.

In manners described herein, proposed weight values may be defined for one or more data points within a dataset. The proposed weight values may be defined by one or more sources and may be combined to generate a weight value for each data point in the dataset. Further, a weighting scheme may be generated using all weight values for all data points in the dataset. In this manner, the weighting scheme may be used to improve performance of an AI model.

It will be appreciated that the server computer system 120 may perform additional operations once the weighting scheme has been defined. For example, the server computer system 120 may generate a data file that includes a list of all weighting schemes in association with the data points of the data set. The data file may be stored in a database and may be used for fine-tuning the data set. The data file may additionally be sent via electronic communication to one or more recipients.

It will be appreciated that in one or more embodiments, one or more steps of the method 400 may be continuously performed and this may be done to fine-tune the weighting values and thus the weighting scheme for the data set. In one or more embodiments, the frequency at which the steps of the method 400 are performed may be defined or otherwise configured by an admin. For example, the steps of the method 400 may be performed every time a training cycle of an AI model is performed. As another example, the steps of the method 400 may be performed every day, week, month, quarter, year, etc.

In manners described herein, different sources may be used to generate proposed weight values for different data points. By using different sources, the proposed weight values may come from distinct or unique sources and may be combined to generate a more accurate weight value for the data point. In embodiments where one or more of the steps of the method 400 are continuously performed, a different source may be assigned to generate a new proposed weight value for a data point. For example, a first iteration of the method may assign a first source to generate a first weight value for a first data point. During a second iteration of the method, a second source may be assigned to generate an updated weight value for the first data point, where the updated weight value may be based on the first weight value. In this manner, different sources may be used to fine-tune the weight values for the dataset.

Although the data set described herein may include a training data set that may be used for training one or more AI models associated with machine learning and/or neural networks, it will be appreciated that the weighting scheme may be defined for other types of data sets. For example, the data set may include a data set that may be used to assign commission allocations. In one specific example, the sources for generating the proposed weight values may include traders or portfolio managers. The data set may include data points that may be associated with brokers. As such, the traders or portfolio managers may be sent a request to assign a weight value for each broker they have dealt with. The weight values for all data points within the data set may be collected and this may be used to determine a commission allocation for each data point or broker.

As mentioned, in one or more embodiments, analysis of the at least one data point may include analyzing the at least one data point based on defined criteria and this may be done using a graphical user interface that includes at least one interface element for analyzing the at least one data point based on defined criteria. Example graphical user interfaces will now be described.

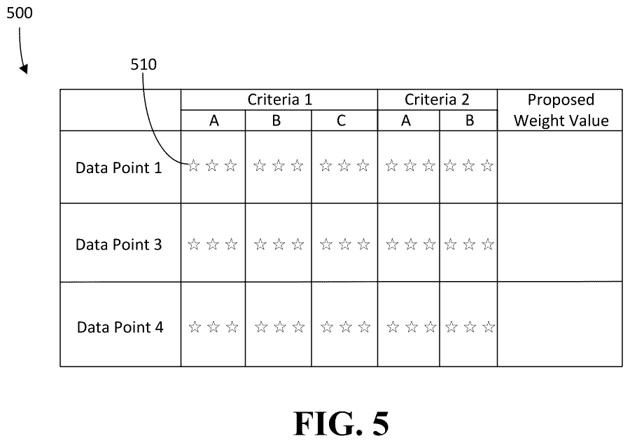

An example graphical user interface 500 is shown in FIG. 5. The graphical user interface 500 may be generated to provide analysis of Data Point 1, Data Point 3, and Data Point 4. Each data point may be analyzed according to defined Criteria 1 and Criteria 2. Criteria 1 includes three sub-categories, specifically sub-categories A, B and C. Criteria 2 includes two subcategories, A and B. The graphical user interface 500 includes interface elements 510 for analyzing the data points based on the defined Criteria 1 and Criteria 2. In this example, the interface elements 510 are in a star format where a source may select a score of 1/3, 2/3 or 3/3. It will be appreciated that different types of interface elements may be used and that different scores or ratings may be assigned.

The graphical user interface 500 may be sent to a computing device associated with a first source for generating a proposed weight value for the data points Data Point 1, Data Point 3, and Data Point 4. The first source may select the interface elements 510 to provide an analysis of Data Point 1, Data Point 3, and Data Point 4. For example, the first source may assign a score of one star for Data Point 1 for Criteria 1 sub-category A and this may be done by performing a mouse click at a location corresponding to the location of the first start of the interface element 510. The first source may complete the analysis by selecting a score for all criteria for all data points.

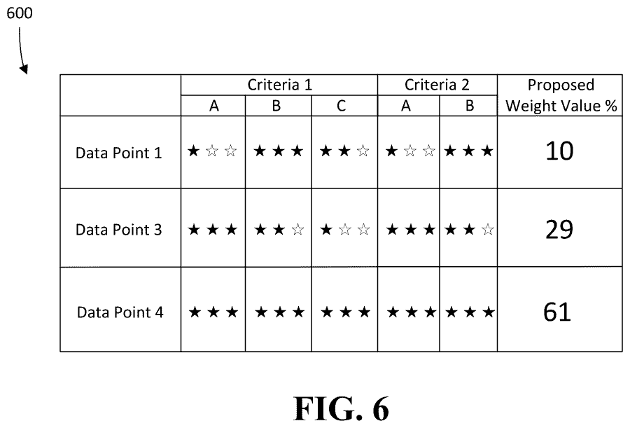

Another example graphical user interface 600 is shown in FIG. 6. The graphical user interface 600 is a completed version of the graphical user interface 500. As can be seen, a score has been assigned for all criteria for all data points.

The analysis may be used by the first source to define the proposed weight value for the data points assigned thereto. For example, the first source may assign the proposed weight values based on the scores provided for each data point. As shown in FIG. 6, the proposed weight values are defined for Data Point 1, Data Point 3, and Data point 4. It will be appreciated that the first source may be required to define the proposed weight values such that the total of all weight values is 100%.

In one or more embodiments, the server computer system 120 may automatically assign the proposed weight values based on the scores entered by the first source. For example, each star displayed on the graphical user interface may be assigned a value of one (1) and the server computer system 120 may determine the proposed weight value based on how many stars have been selected for each data point. It will be appreciated that different criteria may be more important than others and as such some of the criteria may have stars that have a greater weight than others. The weighting of the defined criteria may be configured by an admin and/or may be configured based on historical data.

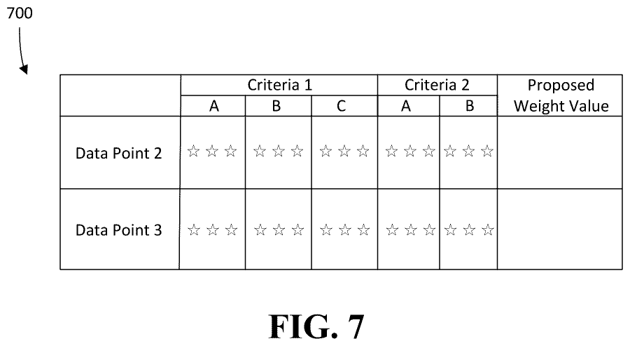

As mentioned, different sources may be assigned different data points to generate proposed weight values for. Another example graphical user interface 700 is shown in FIG. 7. The graphical user interface 700 may be generated to provide analysis of Data Point 2 and Data Point 3. Each data point may be analyzed according to defined Criteria 1 and Criteria 2. Criteria 1 includes three sub-categories, specifically sub-categories A, B and C. Criteria 2 includes two subcategories, A and B. The graphical user interface may be sent to a computing device associated with a second source for generating a proposed weight value for the data points Data Point 2 and Data Point 3.

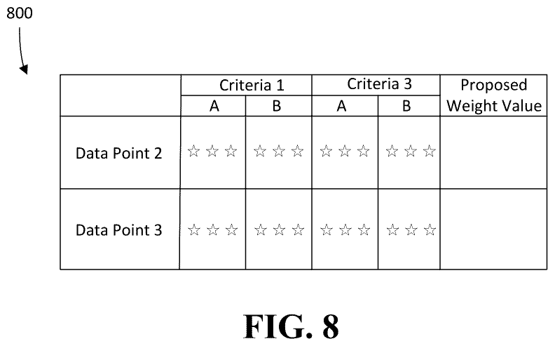

In one or more embodiments, different criteria may be used by different sources to analyze the data points. Another example graphical user interface 800 is shown in FIG. 8. The graphical user interface 800 may be generated to provide analysis of Data Point 2 and Data Point 3. Each data point may be analyzed according to defined Criteria 1 and Criteria 3. Criteria 1 includes three sub-categories, specifically sub-categories A and B. Criteria 3 includes two subcategories, A and B. The graphical user interface may be sent to a computing device associated with a third source for generating a proposed weight value for the data points Data Point 2 and Data Point 3.

It will be appreciated that in generating the graphical user interfaces, the server computer system 120 may determine what data points and what criteria are to be used and this may be based on the source identified to receive the graphical user interface. For example, the server computer system 120 may maintain a lookup table that may include a list of all sources and map each source to a list of criteria to be used to analyze the data points. In this manner, the server computer system 120 may consult the lookup table to generate the graphical user interface and this may be done for each source.

As mentioned, the graphical user interfaces may include interface elements for analyzing the data points according to defined criteria. In embodiments where the data set includes a training data set that may be used for training one or more AI modules associated with machine learning and/or neural networks, the criteria used to analyze the data points may include one or more of class imbalance, data important or priority, misclassification costs, data quality or reliability, temporal or spatial considerations, performance evaluation, fairness considerations, etc. In embodiments where the data set includes a data set used to assign commissions, the criteria used to analyze the data points may include one or more of frequency, satisfaction, analytical tools, research report, analyst contact, sales contact, etc.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
a communications module;
at least one processor coupled to the communications module; and
a memory coupled to the at least one processor and storing processor-executable instructions which, when executed by the at least one processor, configure the at least one processor to:
send, via the communications module, a request for a proposed weight value for at least one data point in a dataset;
receive, via the communications module, the proposed weight value for the at least one data point based on analysis of the at least one data point;
define a weighting scheme for the dataset based at least on the proposed weight value for the at least one data point; and
apply the weighting scheme to the dataset.

2. The computer system of claim 1, wherein the at least one data point includes a first data point and the processor-executable instructions, when executed by the at least one processor, further configure the at least one processor to:
identify a first source for generating a first proposed weight value for the first data point;
send, via the communications module and to a computing device associated with the first source, a request for the first proposed weight value for the first data point; and
receive, via the communications module and from the computing device associated with the first source, the first proposed weight value for the first data point.

3. The computer system of claim 2, wherein the processor-executable instructions, when executed by the at least one processor, further configure the at least one processor to:
identify a second source for generating a second proposed weight value for the first data point;
send, via the communications module and to a computing device associated with the second source, a request for the second proposed weight value for the first data point; and
receive, via the communications module and from the computing device associated with the second source, the second proposed weight value for the first data point.

4. The computer system of claim 3, wherein the processor-executable instructions, when executed by the at least one processor, further configure the at least one processor to:
define a weight value for the first data point based at least on the first proposed weight value and the second proposed weight value.

5. The computer system of claim 1, wherein the at least one data point includes a first data point and a second data point and the processor-executable instructions, when executed by the at least one processor, further configure the at least one processor to:
identify a first source for generating a first proposed weight value for the first data point and a second source for generating a second proposed weight value for the second data point;
send, via the communications module and to a computing device associated with the first source, a request for the first proposed weight value for the first data point;
send, via the communications module and to a computing device associated with the second source, a request for the second proposed weight value for the second data point;
receive, via the communications module and from the computing device associated with the first source, the first proposed weight value for the first data point; and
receive, via the communications module and from the computing device associated with the second source, the second proposed weight value for the second data point.

6. The computer system of claim 5, wherein the processor-executable instructions, when executed by the at least one processor, further configure the at least one processor to:
define the weighting scheme based at least on the first proposed weight value for the first data point and the second proposed weight value for the second data point.

7. The computer system of claim 1, wherein the weighting scheme includes a weight value for each identified data point in the dataset.

8. The computer system of claim 1, wherein the processor-executable instructions, when executed by the at least one processor, further configure the at least one processor to:
determine a trigger condition; and
responsive to determining the trigger condition, send, via the communications module, the request for the proposed weight value for the at least one data point.

9. The computer system of claim 1, wherein the analysis of the at least one data point includes analyzing the at least one data point based on defined criteria.

10. The computer system of claim 9, wherein sending the request for the proposed weight value of the at least one data point includes sending, via the communications module, a graphical user interface that includes at least one interface element for analyzing the at least one data point based on the defined criteria.

11. A computer-implemented method comprising:
sending, via a communications module, a request for a proposed weight value for at least one data point in a dataset;
receiving, via the communications module, the proposed weight value for the at least one data point based on analysis of the at least one data point;
defining a weighting scheme for the dataset based at least on the proposed weight value for the at least one data point; and
applying the weighting scheme to the dataset.

12. The computer-implemented method of claim 11, wherein the at least one data point includes a first data point and the method further comprises:
identifying a first source for generating a first proposed weight value for the first data point;
sending, via the communications module and to a computing device associated with the first source, a request for the first proposed weight value for the first data point; and
receiving, via the communications module and from the computing device associated with the first source, the first proposed weight value for the first data point.

13. The computer-implemented method of claim 12, further comprising:
identifying a second source for generating a second proposed weight value for the first data point;
sending, via the communications module and to a computing device associated with the second source, a request for the second proposed weight value for the first data point; and
receiving, via the communications module and from the computing device associated with the second source, the second proposed weight value for the first data point.

14. The computer-implemented method of claim 13, further comprising:
defining a weight value for the first data point based at least on the first proposed weight value and the second proposed weight value.

15. The computer-implemented method of claim 11, wherein the at least one data point includes a first data point and a second data point and the method further comprises:
identifying a first source for generating a first proposed weight value for the first data point and a second source for generating a second proposed weight value for the second data point;
sending, via the communications module and to a computing device associated with the first source, a request for the first proposed weight value for the first data point;
sending, via the communications module and to a computing device associated with the second source, a request for the second proposed weight value for the second data point;
receiving, via the communications module and from the computing device associated with the first source, the first proposed weight value for the first data point; and
receiving, via the communications module and from the computing device associated with the second source, the second proposed weight value for the second data point.

16. The computer-implemented method of claim 15, further comprising:
defining the weighting scheme based at least on the first proposed weight value for the first data point and the second proposed weight value for the second data point.

17. The computer-implemented method of claim 11, wherein the weighting scheme includes a weight value for each identified data point in the dataset.

18. The computer-implemented method of claim 11, wherein the analysis of the at least one data point includes analyzing the at least one data point based on defined criteria.

19. (canceled)

20. A non-transitory computer readable medium having stored thereon processor-executable instructions which, when executed by at least one processor, configure the at least one processor to:
send, via a communications module, a request for a proposed weight value for at least one data point in a dataset;
receive, via the communications module, the proposed weight value for the at least one data point based on analysis of the at least one data point;
define a weighting scheme for the dataset based at least on the proposed weight value for the at least one data point; and
apply the weighting scheme to the dataset.

21. The computer system of claim 2, wherein the first source includes an artificial intelligence module trained to analyze data sets to identify potential biases within the dataset.
